(19) United States
(12) Patent Application Publication
(10) Pub. No.: US 2024/0357147 A1
(43) Pub. Date: Oct. 24, 2024

(54) DISPLACEMENT PACKING USING SINGLE LoD PER BLOCK

(71) Applicants: SONY GROUP CORPORATION, Tokyo (JP); Sony Corporation of America, New York, NY (US)

(72) Inventor: Danillo Graziosi, Flagstaff, AZ (US)

(21) Appl. No.: 18/368,508

(22) Filed: Sep. 14, 2023

Related U.S. Application Data
(60) Provisional application No. 63/496,968, filed on Apr. 19, 2023.

(51) Int. Cl. H04N 19/46; H04N 19/176; H04N 19/597

(52) U.S. Cl. CPC H04N 19/46; H04N 19/176; H04N 19/597

(57) ABSTRACT

The single Level-of-Detail (LoD) per block displacement packing method enables slice decoding, scalability and other video processing implementations. The sequence displacement bitrate is only minimally changed by using the LoD per block packing implementation.

### CROSS-REFERENCE TO RELATED APPLICATION(S)

This application claims priority under 35 U.S.C. § 119 (e) of the U.S. Provisional Patent Application Ser. No. 63/496,968, filed Apr. 19, 2023 and titled, “DISPLACEMENT PACKING USING SINGLE LOD PER BLOCK,” which is hereby incorporated by reference in its entirety for all purposes.

### FIELD OF THE INVENTION

The present invention relates to three dimensional graphics. More specifically, the present invention relates to dynamic mesh coding.

### BACKGROUND OF THE INVENTION

Recently, a novel method to compress volumetric content, such as point clouds, based on projection from 3D to 2D is being standardized. The method, also known as V3C (visual volumetric video-based compression), maps the 3D volumetric data into several 2D patches, and then further arranges the patches into an atlas image, which is subsequently encoded with a video encoder. The atlas images correspond to the geometry of the points, the respective texture, and an occupancy map that indicates which of the positions are to be considered for the point cloud reconstruction.

In 2017, MPEG had issued a call for proposal (CfP) for compression of point clouds. After evaluation of several proposals, currently MPEG is considering two different technologies for point cloud compression: 3D native coding technology (based on octree and similar coding methods), or 3D to 2D projection, followed by traditional video coding. In the case of dynamic 3D scenes, MPEG is using a test model software (TMC2) based on patch surface modeling, projection of patches from 3D to 2D image, and coding the 2D image with video encoders such as HEVC. This method has proven to be more efficient than native 3D coding, and is able to achieve competitive bitrates at acceptable quality.

Due to the success for coding 3D point clouds of the projection-based method (also known as the video-based method, or V-PCC), the standard is expected to include in future versions further 3D data, such as 3D meshes. However, current version of the standard is only suitable for the transmission of an unconnected set of points, so there is nomechanism to send the connectivity of points, as it is required in 3D mesh compression.

Methods have been proposed to extend the functionality of V-PCC to meshes as well. One possible way is to encode the vertices using V-PCC, and then the connectivity using a mesh compression approach, like TFAN or Edgebreaker. The limitation of this method is that the original mesh has to be dense, so that the point cloud generated from the vertices is not sparse and can be efficiently encoded after projection. Moreover, the order of the vertices affect the coding of connectivity, and different method to reorganize the mesh connectivity have been proposed. An alternative way to encode a sparse mesh is to use the RAW patch data to encode the vertices position in 3D. Since RAW patches encode (x,y,z) directly, in this method all the vertices are encoded as RAW data, while the connectivity is encoded by a similar mesh compression method, as mentioned before. Notice that in the RAW patch, the vertices may be sent in any preferred order, so the order generated from connectivity encoding can be used. The method can encode sparse point clouds, however, RAW patches are not efficient to encode 3D data, and further data such as the attributes of the triangle faces may be missing from this approach.

UVAtlas from Microsoft is the state-of-the-art automatic texture map generation, but requires a significant amount of time, and does optimization for a local frame only. V-PCC generates patches using orthographic projections, but targets point clouds only, so it does not address patch generation for meshes.

### SUMMARY OF THE INVENTION

The single Level-of-Detail (LoD) per block displacement packing method enables slice decoding, scalability and other video processing implementations. The sequence displacement bitrate is only minimally changed by using the LoD per block packing implementation.

In another aspect, a method programmed in a non-transitory memory of a device comprises packing displacement information of a single Level-of-Detail (LoD) into one or more blocks and packing filler bits until an end of a current block of the one or more blocks. The method further comprises repeating the packing displacement information of the single LoD into the one or more blocks and packing the filler bits until the end of the current block of the one or more blocks for subsequent LoDs until all of the displacement information is packed. The method further comprises receiving position count information which indicates where each LoD begins and ends. Each subsequent LoD begins at a beginning of a block. The method further comprises triggering LoD per block displacement packing with a flag. The method further comprises dividing mesh information into different LoDs. The method further comprises performing slice decoding. The method further comprises decoding the displacement information.

In another aspect, an apparatus comprises a non-transitory memory for storing an application, the application for: packing displacement information of a single Level-of-Detail (LoD) into one or more blocks and packing filler bits until an end of a current block of the one or more blocks and a processor coupled to the memory, the processor configured for processing the application. The application is further configured for repeating the packing displacement information of the single LoD into the one or more blocks and packing the filler bits until the end of the current block of the one or more blocks for subsequent LoDs until all of the displacement information is packed. The application is further configured for receiving position count information which indicates where each LoD begins and ends. Each subsequent LoD begins at a beginning of a block. The application is further configured for triggering LoD per block displacement packing with a flag. The application is further configured for dividing mesh information into different LoDs. The application is further configured for performing slice decoding. The application is further configured for decoding the displacement information.

In another aspect, a system comprises an encoder configured for encoding a 3D mesh and a decoder configured for: packing displacement information of a single Level-of-Detail (LoD) into one or more blocks and packing filler bits until an end of a current block of the one or more blocks. The decoder is further configured for repeating the packing displacement information of the single LoD into the one or more blocks and packing the filler bits until the end of the current block of the one or more blocks for subsequent LoDs until all of the displacement information is packed. The decoder is further configured for receiving position count information which indicates where each LoD begins and ends. Each subsequent LoD begins at a beginning of a block. The decoder is further configured for triggering LoD per block displacement packing with a flag. The decoder is further configured for dividing mesh information into different LoDs. The decoder is further configured for performing slice decoding. The decoder is further configured for decoding the displacement information.

### BRIEF DESCRIPTION OF THE DRAWINGS

FIG. 1 illustrates a diagram of a V-DMC decoder according to some embodiments.

FIG. 2 illustrates diagrams of the previous packing implementation and the LoD per block packing implementation according to some embodiments.

FIG. 3 illustrates images of displacement packing according to some embodiments.

FIG. 4 illustrates a flowchart of a method of single LoD per block displacement packing according to some embodiments.

FIG. 5 illustrates a block diagram of an exemplary computing device configured to implement the single LoD per block displacement packing method according to some embodiments.

### DETAILED DESCRIPTION OF THE PREFERRED EMBODIMENT

Meshes are composed of a set of polygons usually describing a surface of a volume. An efficient way to encode dynamic meshes is to simplify the mesh to a basemesh, encode the basemesh with any mesh encoder, and then encode the displacement information, that is, the differences between the subdivided base mesh and the original input mesh. The displacement information is provided per vertex and can be efficiently encoded with video. The displacement information is packed in the video data in a raster scan order, one level-of-detail (LoD) after another. This prevents from using video tools that enable independent coding of blocks (such as slices), since in one single block, there may be two or more LoDs data together.

A method to pack the displacement information is described herein, first dividing mesh information into level-of-details, and then packing each level-of-detail data in separate blocks. This allows for slice decoding of separate LoDs, also enabling scalability in the decoder side. Additionally, a signal in the high-level syntax is provided that allows for the block packing of different LoDs. For example, the basemesh is level 0, and each edge is divided in half, and all the vertices in a half are level 1, and as the edges are divided in half, there are new levels (e.g., level 2, 3 and so on). Other tricks are able to be performed based on the different LoDs. If a LoD does not fill a block, then the remaining bits of the block are able to be filled with zeroes or another filler, so that the next LoD starts at the being of the next block.

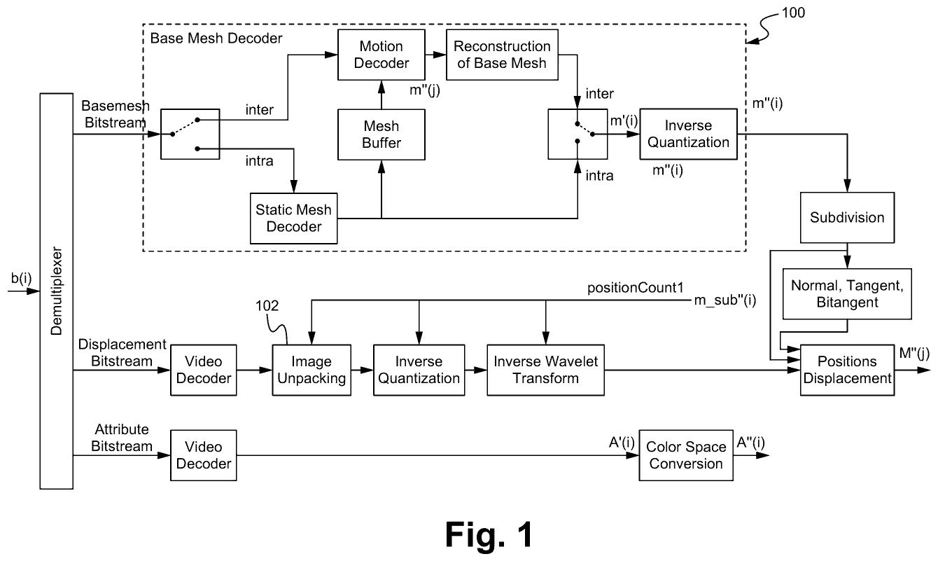

FIG. 1 illustrates a diagram of a V-DMC decoder according to some embodiments. A V-DMC decoder 100 includes many standard components. An image unpacking component 102 is used to implement the displacement packing using a single LoD per block. After the subdivision component, a positionCount1 and the LoDs are generated which go to the image unpacking component 102. The positionCount1 is able to be used to know where each LoD starts and finishes.

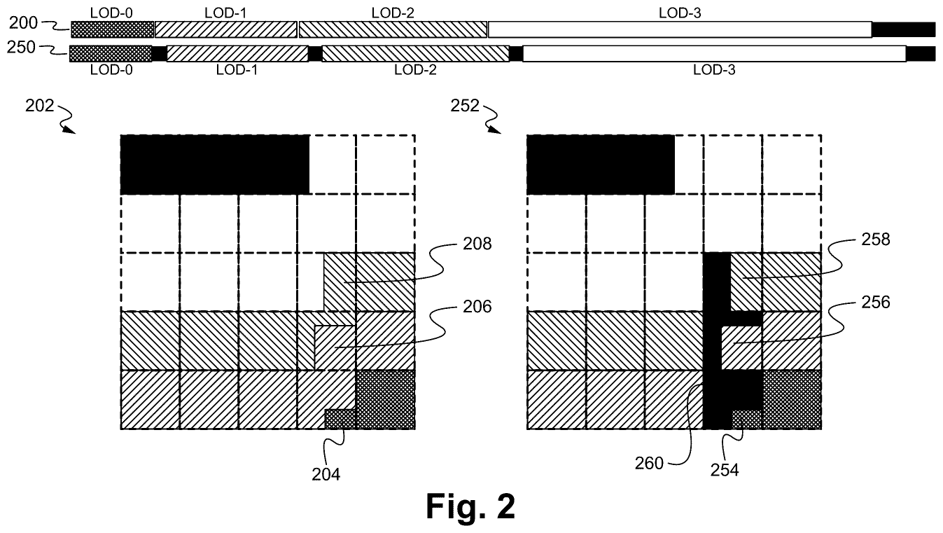

FIG. 2 illustrates diagrams of the previous packing implementation and the LoD per block packing implementation according to some embodiments. The displacement packing stream 200 shows each LoD packed immediately after each other (e.g., LoD-0 immediately followed by LoD-1 and so on). The displacement packing stream 202 shows a gap of fillers between each LoD (e.g., LoD-0 followed by zeroes and then LoD-1 and so on).

Image 202 illustrates the previous packing implementation where each LoD is packed immediately after each other with no gap in between such that different LoDs are able to be in the same block. For example, blocks 204, 206 and 208 show two different LoDs in the same block. Furthering the example, block 204 includes LoD-0 and LoD-1 in the same block, block 206 includes LoD-1 and LoD-2 in the same block, and block 208 includes LoD-2 and LoD-3 in the same block. The different LoDs have distinct shading/hatching/patterns to distinguish each one from the other. For example, in the Figure, LoD-0 has a cross hatch pattern, LoD-1 has lines going from the lower left to the upper right, and so on.

Image 252 illustrates the LoD per block packing implementation where the LoDs are not allowed to occupy the same block. For example, filler bits 260 (e.g., bits equal to 0) are used to take up space to prevent multiple LoDs from occupying the same block. Furthering the example, LoD-0 ends in block 254, so filler bits 260 are used to fill block 254. Then LoD-1 is able to be packed in the next block. LoD-1 ends at block 256, so filler bits 260 fill the remainder of block 256. Then LoD-2 begins at the next block and ends at block 258 which is filled with filler bits 260. LoD-3 then begins at the next block until it ends, and the remainder of the blocks are filled with filler bits 260. Although there are more “edges” in the video image, by only having one LoD per block, slice decoding and other video processing techniques are able to be implemented.

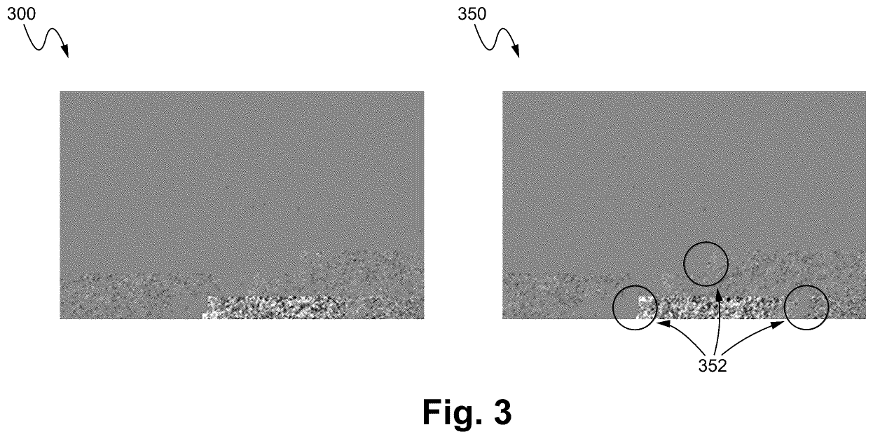

FIG. 3 illustrates images of displacement packing according to some embodiments. Image 300 shows the video image with the previous packing implementation. Image 350 shows the video image with the LoD per block packing implementation. Gaps 352 are shown as described herein where filler bits are used to ensure that two different LoDs are not in the same block. The sequence displacement bitrate is only minimally changed by using the LoD per block packing implementation; however, slice decoding is now possible, whereas slice decoding was not able to be performed with the previous packing implementation. For example, if it is desired to decode a first level, all of the video does not need to be decoded, just the first two blocks are decoded, since the first level is contained in just the first two blocks.

The exemplary syntax for the LoD packing includes:

```
bool
VMCEncoder::computeDisplacementVideoFramePerLoD(
  const VMCFrame& frame,
  Frame<uint16_t>&
  dispVideoFrame, // , ColourSpace::YUV400p, ColourSpace::YUV444p
  const VMCEncoderParameters& params) {
  const auto pixelsPerBlock =
    params.geometryVideoBlockSize * params.geometryVideoBlockSize;
  const auto shift = uint16_t((1 << params.geometryVideoBitDepth) >> 1);
  const auto& disp = frame.disp;
  const auto planeCount = dispVideoFrame.planeCount( );
  for (int32_t p = 0; p < planeCount; ++p) {
    dispVideoFrame.plane(p).fill(shift);
  }
  auto numLods = frame.subdivInfoLevelOfDetails.size( );
  std::vector<int> numBlocksInLod;
  numBlocksInLod.resize(numLods,0);
  numBlocksInLod[0] = std::ceil((double)frame.subdivInfoLevelOfDetails[0].pointCount /
(double)pixelsPerBlock);
  for (int i = 1; i < numLods; i++) {
    auto& prevlod = frame.subdivInfoLevelOfDetails[i−1];
    auto& lod = frame.subdivInfoLevelOfDetails[i];
    int numPointsInLoD = lod.pointCount − prevlod.pointCount;
    numBlocksInLod[i] = std::ceil((double)numPointsInLoD / (double)pixelsPerBlock);
  }
  const int32_t totalBlocksInVideoFrame = (dispVideoFrame.width( ) *
dispVideoFrame.height( ) − 1) / pixelsPerBlock;
  int startBlock = 0;
  for (int32_t lodIdx = 0; lodIdx < numLods; lodIdx++) {
    auto& lod = frame.subdivInfoLevelOfDetails[lodIdx];
    int vStart = 0;
    int vEnd = lod.pointCount;
    if (lodIdx > 0) {
      auto& prevlod = frame.subdivInfoLevelOfDetails[lodIdx − 1];
      vStart = prevlod.pointCount;
      startBlock += numBlocksInLod[lodIdx − 1];
    }
    for (int32_t v = vStart; v < vEnd; ++v) {
      const auto& d = disp[v];
      auto blockIndex = (v − vStart) / pixelsPerBlock + startBlock;
      auto indexWithinBlock = (v − vStart) % pixelsPerBlock;
      if (params.displacementReversePacking) {
        blockIndex = totalBlocksInVideoFrame − blockIndex;
        indexWithinBlock = pixelsPerBlock − 1 − indexWithinBlock;
      }
      const auto x0 = (blockIndex % params.geometryVideoWidthInBlocks)
        * params.geometryVideoBlockSize;
      const auto y0 = (blockIndex / params.geometryVideoWidthInBlocks)
        * params.geometryVideoBlockSize;
      int32_t x = 0;
      int32_t y = 0;
      computeMorton2D(indexWithinBlock, x, y);
      assert(x < params.geometryVideoBlockSize);
      assert(y < params.geometryVideoBlockSize);
      const auto x1 = x0 + x;
      const auto y1 = y0 + y;
      for (int32_t p = 0; p < planeCount; ++p) {
        const auto dshift = int32_t(shift + d[p]);
        assert(dshift >= 0 && dshift < (1 << params.geometryVideoBitDepth));
        dispVideoFrame.plane(p).set(y1, x1, uint16_t(dshift));
      }
    }
  }
  return true;
}
if (_sps.displacementLoDPacking) {
      reconstructDisplacementFromVideoFramePerLod(dispVideo.frame(frameIndex),
        frame,
        rec,
        _sps.geometryVideoBlockSize,
        _sps.geometryVideoBitDepth,
        _sps.displacementReversePacking);
    }
    else {
      reconstructDisplacementFromVideoFrame(dispVideo.frame(frameIndex),
        frame,
        rec,
        _sps.geometryVideoBlockSize,
        _sps.geometryVideoBitDepth,
        _sps.displacementReversePacking);
    }
static int32_t
reconstructDisplacementFromVideoFramePerLod(
  const Frame<uint16_t>& dispVideoFrame,
  VMCFrame& frame,
  const TriangleMesh<MeshType>& rec,
```

| | |
|---|---|
| const int32_t | geometryVideoBlockSize, |
| const int32_t | geometryVideoBitDepth, |
| const int32_t | displacementReversePacking) { |

```
  printf(“Reconstruct displacements from video frame per LoD\n”);
  fflush(stdout);
  const auto geometryVideoWidthInBlocks =
    disp VideoFrame.width( ) / geometryVideoBlockSize;
  const auto pixelsPerBlock = geometryVideoBlockSize * geometryVideoBlockSize;
  const auto shift = uint16_t((1 << geometryVideoBitDepth) >> 1);
  const auto planeCount = dispVideoFrame.planeCount( );
  const auto pointCount = rec.pointCount( );
  auto& disp = frame.disp;
  const int32_t totalBlocksInVideoFrame = (dispVideoFrame.width( ) *
dispVideoFrame.height( ) − 1)/ pixelsPerBlock;
  disp.assign(pointCount, Vec3<double>(0));
  auto numLods = frame.subdivInfoLevelOfDetails.size( );
  std::vector<int> numBlocksInLod;
  numBlocksInLod.resize(numLods, 0);
  numBlocksInLod[0] = std::ceil((double)frame.subdivInfoLevelOfDetails[0].pointCount /
(double)pixelsPerBlock);
  for (int i = 1; i < numLods; i++) {
    auto& prevlod = frame.subdivInfoLevelOfDetails[i − 1];
    auto& lod = frame.subdivInfoLevelOfDetails[i];
    int numPointsInLoD = lod.pointCount − prevlod.pointCount;
    numBlocksInLod[i] = std::ceil((double)numPointsInLoD / (double)pixelsPerBlock);
  }
  int startBlock = 0;
  for (int32_t lodIdx = 0; lodIdx < numLods; lodIdx++) {
    auto& lod = frame.subdivInfoLevelOfDetails[lodIdx];
    int vStart = 0;
    int vEnd = lod.pointCount;
    if (lodIdx > 0) {
      auto& prevlod = frame.subdivInfoLevelOfDetails[lodIdx − 1];
      vStart = prevlod.pointCount;
      startBlock += numBlocksInLod[lodIdx − 1];
    }
    for (int32_t v = vStart; v < vEnd; ++v) {
      auto blockIndex = (v − vStart) / pixelsPerBlock + startBlock;
      auto indexWithinBlock = (v − vStart) % pixelsPerBlock;
      if (displacementReversePacking) {
        blockIndex = totalBlocksInVideoFrame − blockIndex;
        indexWithinBlock = pixelsPerBlock − 1 − indexWithinBlock;
      }
      const auto x0 = (blockIndex % geometryVideoWidthInBlocks)
        * geometryVideoBlockSize;
      const auto y0 = (blockIndex / geometryVideoWidthInBlocks)
        * geometryVideoBlockSize;
      int32_t x = 0;
      int32_t y = 0;
      computeMorton2D(indexWithinBlock, x, y);
      assert(x < geometryVideoBlockSize);
      assert(y < geometryVideoBlockSize);
      const auto x1 = x0 + x;
      const auto y1 = y0 + y;
      auto& d = disp[v];
      for (int32_t p = 0; p < planeCount; ++p) {
        const auto& plane = dispVideoFrame.plane(p);
        d[p] = double(plane.get(y1, x1)) − shift;
      }
    }
  }
  return 0;
}
```

### Atlas Sequence Parameter Set Extension RBSP Syntax

| | Descriptor |
|---|---|
| asps_vmc_extension( ) { | |
| asps_vmc_ext_prevent_geometry_video_conversion_flag | u(1) |
| asps_vmc_ext_prevent_attribute_video_conversion_flag | u(1) |
| asps_vmc_ext_subdivision_method | u(3) |

if(asps_vmc_ext_subdivision_method != 0)

| | |
|---|---|
| asps_vmc_ext_subdivision_iteration_count | u(8) |
| asps_vmc_ext_displacement_coordinate_system | u(1) |
| asps_vmc_ext_transform_method | u(3) |
| if(asps_vmc_ext_transform_method == LINEAR_LIFTING) { | |
| vmc_lifting_transform_parameters( 0, 0 ) | |
| } | u(7) |
| asps_vmc_ext_num_attribute_video | |
| for(i=0; i< asps_vmc_ext_num_attribute_video; i++){ | |
| asps_vmc_ext_attribute_type_id [ i ] | u(8) |
| asps_vmc_ext_attribute_frame_width[ i ] | ue(v) |
| asps_vmc_ext_attribute_frame_height[ i ] | ue(v) |
| asps_vmc_vmc_ext_attribute_transform_method[ i ] | u(3) |
| if(asps_vmc_ext_attribute_transform_method == LINEAR_LIFTING ) { | |
| vmc_lifting_transform_parameters(i+1, 0) | |
| asps_vmc_ext_direct_attribute_projection_enabled_flag[ i ] | u(1) |
| } | |
| asps_vmc_ext_packing_method | u(1) |
| asps_vmc_ext_lod_block_packing | u(1) |

As shown, a flag (asps_vmc_ext_lod_block_packing) is able to be set for LoD block packing. asps_vmc_ext_lod_block_packing equal to 1 indicates that the displacement components are packed per level-of-detail, respecting the block boundary. asps_vmc_ext_duplicate_vertex_removal_flag equal to 0 indicates that the displacement of all the level-of-details are packed together.

Next, the inverse packing process is invoked with the parameters width, height, bitDepth, dispQuantCoeffFrame, blockSize, positionCount1, inverseDisplacementPacking, lodBlockPacking, subdivisionIterationCount and levelOfDetailPositionCounts as inputs, and the parameter dispQuantCoeffArray as output.

```
if( lodBlockPacking ) {
  blocksInVideo = ( width * height − 1 ) / pixelsPerBlock
  numBlocksInLod[ 0 ] =
              ( levelOfDetailAttributeCounts[ 0 ] + pixelsPerBlock /
              2 ) / pixelsPerBlock
      for( i = 1; i < subdivisionIterationCount + 1; i++ ) {
            numBlocksInLod[ i ] =
              ( levelOfDetailAttributeCounts[ i ] −
              levelOfDetailAttributeCounts[ i − 1 ]
              + pixelsPerBlock / 2 ) / pixelsPerBlock
      }
      startBlock = 0
      for( lodIdx = 0; lodIdx < subdivisionIterationCount + 1;
      lodIdx++ ) {
        vStart = 0
        vEnd = levelOfDetailAttributeCounts[ lodIdx ]
        if ( lodIdx > 0 ) {
          vStart = levelOfDetailAttributeCounts[ lodIdx − 1 ]
          startBlock = startBlock + numBlocksInLod[ lodIdx − 1 ]
        }
        for( v = vStart; v < vEnd; v++ ) {
          blockIndex = v / pixelsPerBlock
          indexWithinBlock = v % pixelsPerBlock
          if( inverseDisplacementPacking ){
            blockIndex = blocksInVideo − blockIndex
            indexWithinBlock = pixelsPerBlock − 1 −
            indexWithinBlock
      }
      x0 = (blockIndex % widthInBlocks) * blockSize
          y0 = (blockIndex / widthInBlocks) * blockSize
          ( x, y ) = computeMorton2D(indexWithinBlock)
          x = x0 + x
          y = y0 + y
          for( d = 0; d < 3; d++ ) {
            dispQuantCoeffArray[ v ][ d ] =
            dispQuantCoeffFrame[ x ][ y ][ d ] − shift
          }
    }
      }
} else {
    start = width * height − 1
      for( vIdx = 0; vIdx < positionCount; vIdx++ ) {
        if( inverseDisplacementPacking )
          v = start − vIdx
    else
          v = vIdx
        blockIndex = v / pixelsPerBlock
        indexWithinBlock = v % pixelsPerBlock
        x0 = (blockIndex % widthInBlocks) * blockSize
        y0 = (blockIndex / widthInBlocks) * blockSize
        ( x, y ) = computeMorton2D(indexWithinBlock)
        x = x0 + x
        y = y0 + y
        for( d = 0; d < 3; d++ ) {
          dispQuantCoeffArray[ v ][ d ] =
          dispQuantCoeffFrame[ x ][ y ][ d ] − shift
        }
      }
}
```

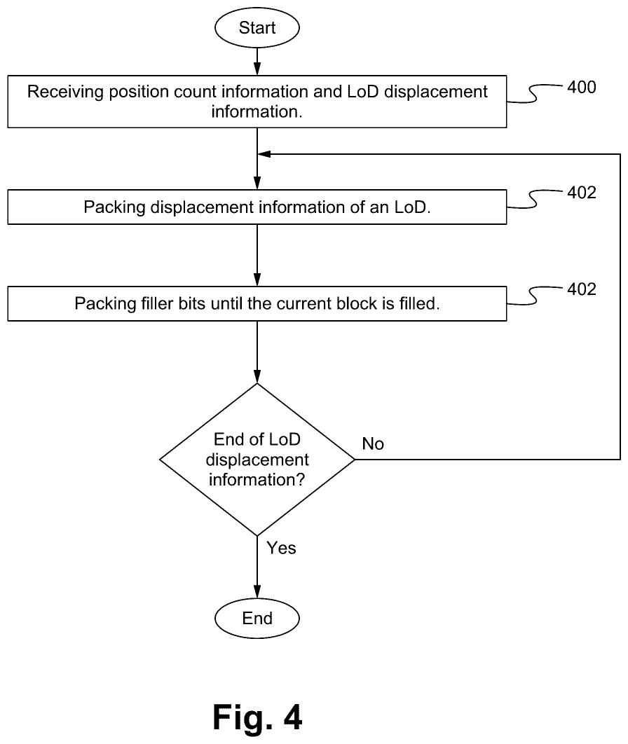

FIG. 4 illustrates a flowchart of a method of single LoD per block displacement packing according to some embodiments. In the step 400, receiving position count information and LoD displacement information. For example, the position count information indicates where each LoD begins and ends. In the step 402, displacement information of a single LoD (e.g., LoD-0) is packed (e.g., in a video bitstream). If the displacement information of the single LoD includes more bits than a single block in the bitstream, then subsequent blocks are filled. Upon reaching the end of the displacement information of the single LoD, filler bits (e.g., zeroes) are packed until the current block is filled, in the step 404. If the displacement information of the LoD ends at the end of the block, then no filler bits are used for that block. The process repeats until the displacement information of each LoD is packed, where each LoD begins at the beginning of a block. For example, displacement information of LoD-0 is packed, followed by filler bits, then displacement information of LoD-1 is packed, followed by filler bits, and so on, until the last LoD (e.g., LoD-n) is packed. In a further example, the displacement information of LoD-0 fills a first block and then part of a second block, so the remainder of the second block is filled with filler bits. Then the displacement information of LoD-1 starts at the beginning of the third block and continues as described. Two LoDs are not in the same block; rather, a single block will only have one LoD and potentially filler bits. In some embodiments, fewer or additional steps are implemented. For example, a step of indicating and/or triggering the LoD per block displacement packing occurs based on a flag. In another example, dividing the mesh information into different LoDs is able to be implemented. In yet another example, the LoD per block displacement packing enables further video processing such as slice decoding and scalability. In some embodiments, decoding of the information is implemented. In some embodiments, the order of the steps is modified.

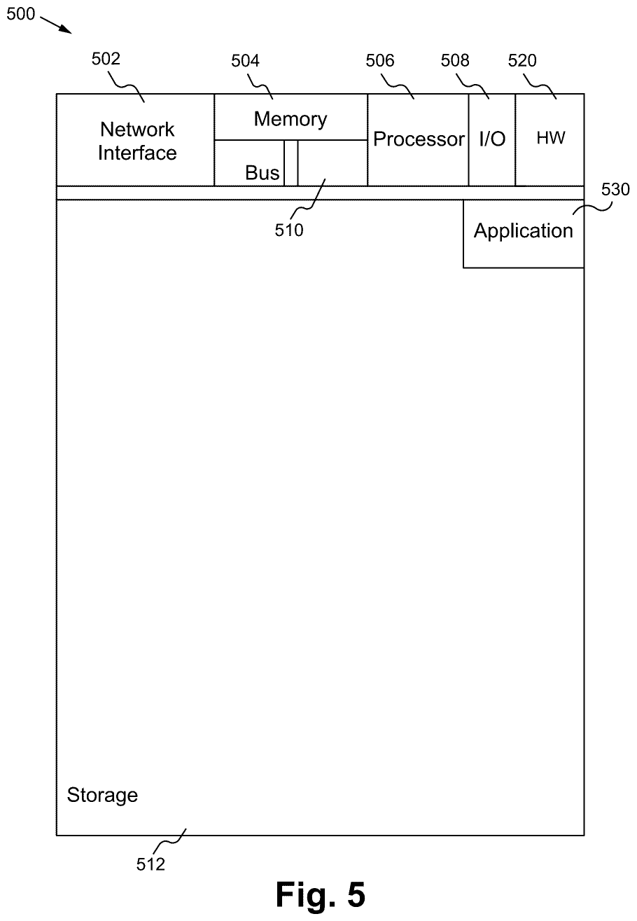

FIG. 5 illustrates a block diagram of an exemplary computing device configured to implement the single LoD per block displacement packing method according to some embodiments. The computing device 500 is able to be used to acquire, store, compute, process, communicate and/or display information such as images and videos including 3D content. The computing device 500 is able to implement any of the encoding/decoding aspects. In general, a hardware structure suitable for implementing the computing device 500 includes a network interface 502, a memory 504, a processor 506, I/O device(s) 508, a bus 510 and a storage device 512. The choice of processor is not critical as long as a suitable processor with sufficient speed is chosen. The memory 504 is able to be any conventional computer memory known in the art. The storage device 512 is able to include a hard drive, CDROM, CDRW, DVD, DVDRW, High Definition disc/drive, ultra-HD drive, flash memory card or any other storage device. The computing device 500 is able to include one or more network interfaces 502. An example of a network interface includes a network card connected to an Ethernet or other type of LAN. The I/O device(s) 508 are able to include one or more of the following: keyboard, mouse, monitor, screen, printer, modem, touchscreen, button interface and other devices. Single LoD per block displacement packing application(s) 530 used to implement the single LoD per block displacement packing method are likely to be stored in the storage device 512 and memory 504 and processed as applications are typically processed. More or fewer components shown in FIG. 5 are able to be included in the computing device 500. In some embodiments, single LoD per block displacement packing hardware 520 is included. Although the computing device 500 in FIG. 5 includes applications 530 and hardware 520 for the single LoD per block displacement packing method, the single LoD per block displacement packing method is able to be implemented on a computing device in hardware, firmware, software or any combination thereof. For example, in some embodiments, the single LoD per block displacement packing applications 530 are programmed in a memory and executed using a processor. In another example, in some embodiments, the single LoD per block displacement packing hardware 520 is programmed hardware logic including gates specifically designed to implement the single LoD per block displacement packing method.

In some embodiments, the single LoD per block displacement packing application(s) 530 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

To utilize the single LoD per block displacement packing method, a device acquires or receives 3D content (e.g., point cloud content). The single LoD per block displacement packing method is able to be implemented with user assistance or automatically without user involvement.

In operation, the single LoD per block displacement packing method enables slice decoding and other video processing implementations. The sequence displacement bitrate is only minimally changed by using the LoD per block packing implementation.

### Some Embodiments of Displacement Packing Using Single LoD Per Block

1. A method programmed in a non-transitory memory of a device comprising:
packing displacement information of a single Level-of-Detail (LoD) into one or more blocks; and
packing filler bits until an end of a current block of the one or more blocks.

2. The method of clause 1 further comprising repeating the packing displacement information of the single LoD into the one or more blocks and packing the filler bits until the end of the current block of the one or more blocks for subsequent LoDs until all of the displacement information is packed.

3. The method of clause 1 further comprising receiving position count information which indicates where each LoD begins and ends.

4. The method of clause 1 wherein each subsequent LoD begins at a beginning of a block.

5. The method of clause 1 further comprising triggering LoD per block displacement packing with a flag.

6. The method of clause 1 further comprising dividing mesh information into different LoDs.

7. The method of clause 1 further comprising performing slice decoding.

8. The method of clause 1 further comprising decoding the displacement information.

9. An apparatus comprising:
a non-transitory memory for storing an application, the application for:
   packing displacement information of a single Level-of-Detail (LoD) into one or more blocks; and
   packing filler bits until an end of a current block of the one or more blocks; and
a processor coupled to the memory, the processor configured for processing the application.

10. The apparatus of clause 9 wherein the application is further configured for repeating the packing displacement information of the single LoD into the one or more blocks and packing the filler bits until the end of the current block of the one or more blocks for subsequent LoDs until all of the displacement information is packed.

11. The apparatus of clause 9 wherein the application is further configured for receiving position count information which indicates where each LoD begins and ends.

12. The apparatus of clause 9 wherein each subsequent LoD begins at a beginning of a block.

13. The apparatus of clause 9 wherein the application is further configured for triggering LoD per block displacement packing with a flag.

14. The apparatus of clause 9 wherein the application is further configured for dividing mesh information into different LoDs.

15. The apparatus of clause 9 wherein the application is further configured for performing slice decoding.

16. The apparatus of clause 9 wherein the application is further configured for decoding the displacement information.

17. A system comprising:
an encoder configured for encoding a 3D mesh; and
a decoder configured for:
   packing displacement information of a single Level-of-Detail (LoD) into one or more blocks; and
   packing filler bits until an end of a current block of the one or more blocks.

18. The system of clause 17 wherein the decoder is further configured for repeating the packing displacement information of the single LoD into the one or more blocks and packing the filler bits until the end of the current block of the one or more blocks for subsequent LoDs until all of the displacement information is packed.

19. The system of clause 17 wherein the decoder is further configured for receiving position count information which indicates where each LoD begins and ends.

20. The system of clause 17 wherein each subsequent LoD begins at a beginning of a block.

21. The system of clause 17 wherein the decoder is further configured for triggering LoD per block displacement packing with a flag.

22. The system of clause 17 wherein the decoder is further configured for dividing mesh information into different LoDs.

23. The system of clause 17 wherein the decoder is further configured for performing slice decoding.

24. The system of clause 17 wherein the decoder is further configured for decoding the displacement information.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
packing displacement information of a single Level-of-Detail (LoD) into one or more blocks; and
packing filler bits until an end of a current block of the one or more blocks.

2. The method of claim 1 further comprising repeating the packing displacement information of the single LoD into the one or more blocks and packing the filler bits until the end of the current block of the one or more blocks for subsequent LoDs until all of the displacement information is packed.

3. The method of claim 1 further comprising receiving position count information which indicates where each LoD begins and ends.

4. The method of claim 1 wherein each subsequent LoD begins at a beginning of a block.

5. The method of claim 1 further comprising triggering LoD per block displacement packing with a flag.

6. The method of claim 1 further comprising dividing mesh information into different LoDs.

7. The method of claim 1 further comprising performing slice decoding.

8. The method of claim 1 further comprising decoding the displacement information.

9. An apparatus comprising:
a non-transitory memory for storing an application, the application for:
packing displacement information of a single Level-of-Detail (LoD) into one or more blocks; and
packing filler bits until an end of a current block of the one or more blocks; and
a processor coupled to the memory, the processor configured for processing the application.

10. The apparatus of claim 9 wherein the application is further configured for repeating the packing displacement information of the single LoD into the one or more blocks and packing the filler bits until the end of the current block of the one or more blocks for subsequent LoDs until all of the displacement information is packed.

11. The apparatus of claim 9 wherein the application is further configured for receiving position count information which indicates where each LoD begins and ends.

12. The apparatus of claim 9 wherein each subsequent LoD begins at a beginning of a block.

13. The apparatus of claim 9 wherein the application is further configured for triggering LoD per block displacement packing with a flag.

14. The apparatus of claim 9 wherein the application is further configured for dividing mesh information into different LoDs.

15. The apparatus of claim 9 wherein the application is further configured for performing slice decoding.

16. The apparatus of claim 9 wherein the application is further configured for decoding the displacement information.

17. A system comprising:
an encoder configured for encoding a 3D mesh; and
a decoder configured for:
packing displacement information of a single Level-of-Detail (LoD) into one or more blocks; and
packing filler bits until an end of a current block of the one or more blocks.

18. The system of claim 17 wherein the decoder is further configured for repeating the packing displacement information of the single LoD into the one or more blocks and packing the filler bits until the end of the current block of the one or more blocks for subsequent LoDs until all of the displacement information is packed.

19. The system of claim 17 wherein the decoder is further configured for receiving position count information which indicates where each LoD begins and ends.

20. The system of claim 17 wherein each subsequent LoD begins at a beginning of a block.

21. The system of claim 17 wherein the decoder is further configured for triggering LoD per block displacement packing with a flag.

22. The system of claim 17 wherein the decoder is further configured for dividing mesh information into different LoDs.

23. The system of claim 17 wherein the decoder is further configured for performing slice decoding.

24. The system of claim 17 wherein the decoder is further configured for decoding the displacement information.
